(19) United States
(12) Patent Application Publication
(10) Pub. No.: US 2010/0310390 A1
(43) Pub. Date: Dec. 9, 2010

(54) FAN

(76) Inventors: Shih-Hsuan HUANG, Taoyuan Hsien (TW); Chia-Ching Lin, Taoyuan Hsien (TW)

Correspondence Address: Muncy, Geissler, Olds & Lowe, PLLC, 4000 Legato Road, Suite 310, FAIRFAX, VA, 22033, US

(21) Appl. No.: 12/617,287

(22) Filed: Nov. 12, 2009

(30) Foreign Application Priority Data
Jun. 5, 2009 (TW) 098209849

(51) Int. Cl. F04D 25/08; H02K 5/10

(52) U.S. Cl. 417/352; 310/88

(57) ABSTRACT

A fan includes a frame, a rotor, a stator, a printed circuit board (PCB), and a water-proof structure. The frame includes a base, a first opening, and a second opening corresponding to the first opening. The base is located at the center of the frame near the second opening. The stator is disposed on the base of the frame. The rotor is disposed in the frame and coupled to the stator. The water-proof structure includes a protection cover and a seal ring. The protection cover is connected with the base, and the PCB is disposed in a closed space formed by the protection cover and the base. The protection cover has an annular wall and the seal ring is disposed around the outer surface of the annular wall of the protection cover.

### CROSS REFERENCE TO RELATED APPLICATIONS

This Non-provisional application claims priority under 35 U.S.C. §119(a) on Patent Application No(s). 098209849 filed in Taiwan, Republic of China on Jun. 5, 2009, the entire contents of which are hereby incorporated by reference.

### BACKGROUND OF THE INVENTION

1. Field of Invention

The present invention relates to a fan and, in particular, to a fan and its stator module and water-proof structure.

2. Related Art

As the technology progresses, the electronic devices tend to have the characteristics of high speed, integrated functions and reduced size such that the integration of the electronic elements increases. As there is more heat generated from the electronic device, the performance of electronic device may be unstable, thereby severely affecting the reliability and making the poor heat dissipation. The fan is commonly used for heat dissipation and usually includes a frame, a stator, and a rotor. The stator is directly disposed in the frame and thus the circuit board of the stator and the electronic elements thereon will be directly exposed to the air. Because these elements are not protected, the circuit board may be short circuit under the contamination of the moisture or dust in the air, hence causing damages and affecting the operation of the electronic device.

A conventional way is to reduce the gap between the frame and the stator so that the circuit board and electronic elements are not easily damaged by the moisture; nonetheless, such a way still cannot fully protect the circuit board and the electronic elements.

In the present technology, the surface of the circuit board is coated with gel to isolate the electronic elements on the circuit board from the air for achieving the water-proof effect. However, since it takes a long time for drying the gel, the manufacturing time is increased. Besides, the bubbles, which are quite difficult to be detected, are easily generated in the gel during the coating process and the surface of the gel can be easily damaged while assembling, so that the moister-proof effect of the product will be affected by its manufacturing process.

### SUMMARY OF THE INVENTION

An object of the present invention is to provide a fan with the water-proof structure. The water-proof structure includes a protection cover and a seal ring. The protection cover is connected to a base of the fan, and has an annular wall. The seal ring is disposed around the outer surface of the annular wall of the protection cover.

Another object of the present invention is to provide a fan including a frame, a circuit board, a stator, a rotor, and a water-proof structure. The frame has a base, a first opening, and a second opening corresponding to the first opening. The base is located at the center of the frame near the second opening. The stator is disposed on the base of the frame and electrically connected to the circuit board. The rotor is disposed in the frame and coupled to the stator. The water-proof structure includes a protection cover connected to the base and the circuit board is located in a closed space defined between the protection cover and the base. The protection cover has an annular wall facing the circuit board. Besides, the seal ring is disposed around the outer surface of the annular wall of the protection cover.

As mentioned above, in the fan of the present invention, the circuit board is disposed in the closed space defined by the protection cover and the base, and the seal ring is disposed between the base and the protection cover for effectively preventing moisture from entering the closed space and the circuit board. Compared to the prior art, the moisture-proof gel is replaced by a mechanical part in the present invention, thus a coating machine will not be needed during manufacturing so as to reduce production cost and the time for drying the gel and detection of the bubbles in the gel. Thus, the present invention can simplify the assembling process, and the manufacturing time can be largely reduced. In addition, since the precision of the protection cover and the seal ring in the present invention can be easily controlled, the seal ring can further adjust the error occurred in assembling. According to the above, the moisture-proof effect of the present invention is not affected by the components and manufacturing process as that in the prior art.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a cross-sectional view of a first embodiment of a fan according to the present invention;

FIG. 2 is an exploded view of a stator module shown in FIG. 1;

FIG. 3 is a top view of a protection cover shown in FIG. 1;

FIG. 4 is a cross-sectional view of the protection cover shown in FIG. 1;

FIG. 5 is an enlarged view of Part A shown in FIG. 4;

FIG. 6 is a schematic view showing that the pin of the stator passes through the hole shown in FIG. 5;

FIG. 7 is a top view of a seal ring of the fan of the present invention; and

FIG. 8 is a cross-sectional view of a second embodiment of a fan according to the present invention.

### DETAILED DESCRIPTION OF THE INVENTION

The present invention will be apparent from the following detailed description, which proceeds with reference to the accompanying drawings, wherein the same references relate to the same elements.

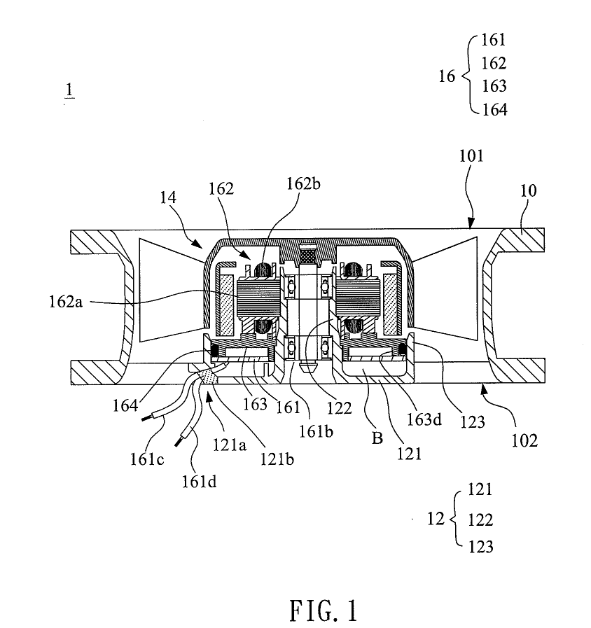

FIG. 1 is a cross-sectional view of the fan according to a first embodiment of the present invention. With reference to FIG. 1, the fan 1 includes a frame 10, a rotor 14, and a stator module 16.

The frame 10 has a first opening 101 (e.g. an air inlet), a second opening 102 corresponding to the first opening 101 (e.g. an air outlet), and a base 12 located at the center of the frame 10 near the second opening 102. The base 12 includes a bottom part 121, a bushing 122 protruded from the center of the bottom part 121 toward the first opening 101, and an extension part 123 extended from the outer periphery of the bottom part 121 toward the first opening 101.

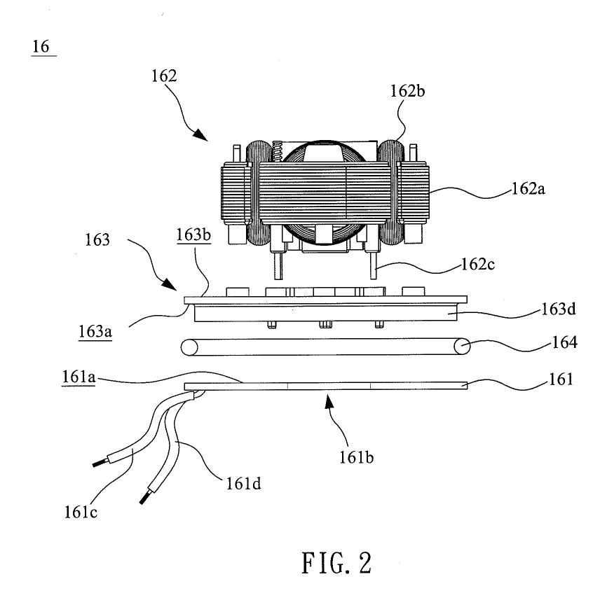

FIG. 2 is an exploded view of the stator module 16 in FIG. 1. With reference to FIG. 2, the stator module 16 includes a circuit board 161, a stator 162, a protection cover 163, and a seal ring 164.

The circuit board 161 includes a surface 161a. Herein, a hole 161b is located at the center of the circuit board 161, and two wires 161c and 161d are connected to the circuit board 161.

The stator 162 includes a plurality of silicon steel sheets 162a, a plurality of coils 162b, and a plurality of pins 162c.

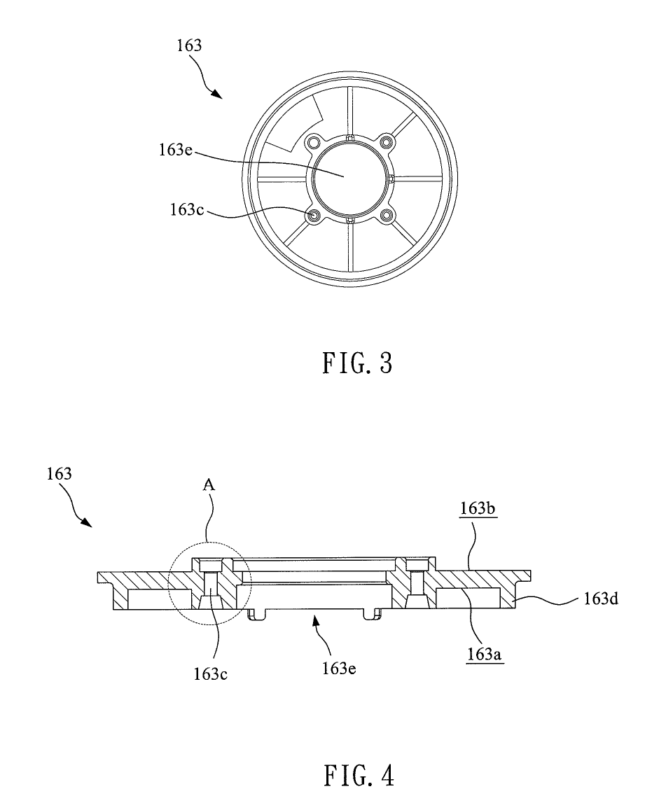

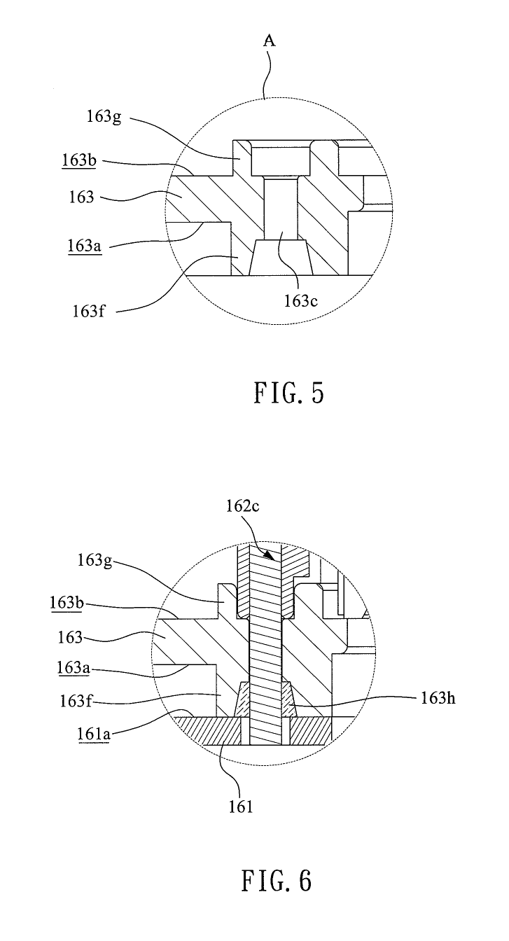

FIG. 3 is a top view of the protection cover 163 in FIG. 1. FIG. 4 is a cross-sectional view of the protection cover 163 in FIG. 1. FIG. 5 is an enlarged view of a part A in FIG. 4. With reference to FIGS. 3 to 5, the protection cover 163 includes a first surface 163a and a second surface 163b opposite to the first surface 163a. The first surface 163a corresponds to the surface 161a of the circuit board 161.

A plurality of holes 163c are disposed on the protection cover 163, and an opening 163e is located at the center of the protection cover 163. The protection cover 163 has an annular wall 163d protruded out of the first surface 163a and adjacent to the outer periphery of the protection cover 163. In addition, the protection cover 163 has a first pin accommodating structure 163f formed on the first surface 163a and around the periphery of each hole 163c, and the second surface 163b of the protection cover 163 protrudes out to form a second pin accommodating structure 163g on the periphery of each hole 163c. The hole 163c in the first pin accommodating structure 163f has an outwardly expanded diameter larger than that of the pin 162c of the stator 162.

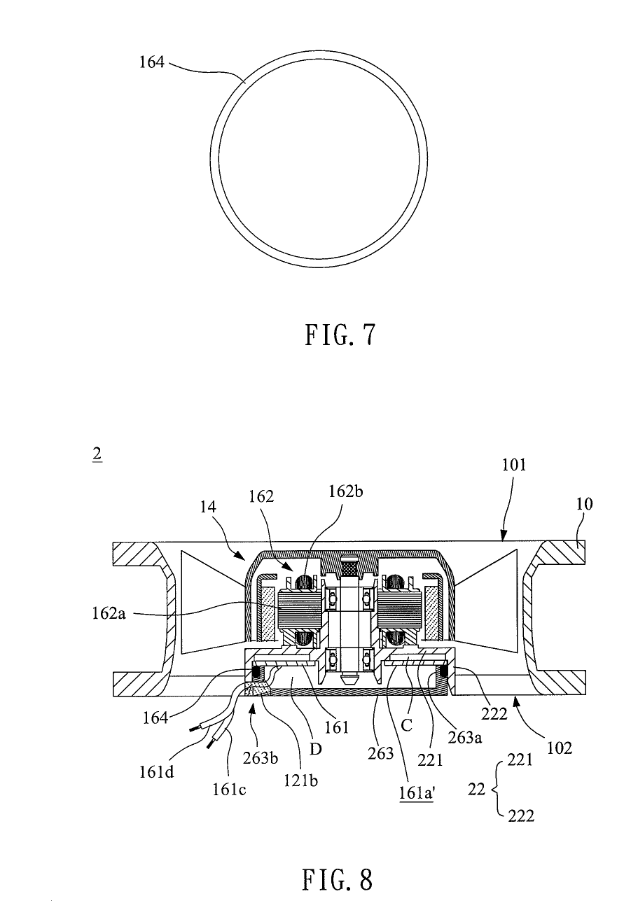

With reference to FIG. 7, the seal ring 164 is in an annular shape and can be made by rubber or silica gel. It can be disposed on the outer surface of the annular wall 163d of the protection cover 163 so that a water-proof structure is formed by the protection cover 163 and the seal ring 164.

Please refer to FIGS. 2 and 6, when the stator module 16 is assembled with the protection cover 163, the pin 162c of the stator 162 passes through the hole 163c of the protection cover 163 to be connected with the circuit board 161 such that the protection cover 163 is located between the stator 162 and the circuit board 161. The annular wall 163d of the protection cover 163 touches against the circuit board 161 (as shown in FIG. 1) and the outer surface of the pin 162c of the stator 162 closely contacts the inner surface of the second pin accommodating structure 163g. Thus, the second pin accommodating structure 163g is capable of preventing the moisture from entering through the second surface 163b of the protection cover 163 to the hole 163c.

With reference to FIGS. 1, 2, and 3, the stator module 16 is disposed on the base 12, and the circuit board 161 is telescoped to the bushing 122 of the base 12 through the hole 161b (as shown in FIG. 2). The protection cover 163 is telescoped to the bushing 122 of the base 12 through the opening 163e (as shown in FIG. 3) and the outer periphery of the protection cover 163 touches against the extension part 123 of the base 12 to form a closed space B with the base 12. The circuit board 161 is located in the closed space B and its surface 161a faces the first opening 101 of the frame 10. The seal ring 164 is disposed between the extension part 123 of the base 12 and the annular wall 163d of the protection cover 163 for securely sealing the closed space B and preventing the moisture from entering.

An outlet 121a is disposed on the base 12, and the wires 161c and 161d pass through the outlet 121a to be connected to the external system (not shown). The outlet 121a is sealed by a moisture-proof gel 121b (or a rubber). In addition, the stator 162 can also be electrically connected to the circuit board 161 via wires rather than the pin 162c.

The first pin accommodating structure 163f formed by the periphery of the hole 163c on the protection cover 163 is similar to the second pin accommodating structure 163g shown in FIG. 5.

With reference to FIG. 6, the hole 163c in the first pin accommodating structure 163f can be filled with the moisture-proof gel 163h for enhancing the water-proof effect to prevent the moisture from entering the closed space B along the pin 162c and the hole 163c.

FIG. 8 is a cross-sectional view of a second embodiment of a fan according to the present invention. The structure of a fan 2 is approximately the same as the fan 1 of the first embodiment, and thus the same elements are labeled with the same reference numerals, respectively. The same description is omitted. The difference between the fan 2 of the second embodiment and the fan 1 of the first embodiment is that the base 22 of the fan 2 includes a bottom part 221 and an extension part 222, and a predetermined distance is set between the bottom part 221 and the second opening 102 (i.e. the air outlet). The extension part 222 protrudes out and extends to the second opening 102 from the outer periphery of the bottom part 221 to form a concave space C with the bottom part 221. The circuit board 161 and the protection cover 263 of the fan 2 are disposed in the concave space C, and the circuit board 161 is located between the protection cover 263 and the bottom part 221 of the base 22. The protection cover 263 has an annular wall 263a protruded from the outer periphery of protection cover 263. A plurality of holes are formed on the bottom part 221 of the base 22. The pin 162c of the stator 162 passes through the holes on the bottom part 22 of the base 22 to be connected to the circuit board 161. The outer periphery of the protection cover 263 touches against the inner surface of the extension part 222 to form a closed space D with the base 22. The seal ring 164 is disposed between the extension part 222 of the base 22 and the annular wall 263a of the protection cover 263. An outlet 263b is set on a proper location on the protection cover 263, and the wires 161c and 161d pass through the outlet 263b to be connected to the external system.

The bottom surface and top surface of the bottom part 221 of the base 22 can also have the first and second pin accommodating structures at two ends of the hole for enhancing the water-proof effect.

To sum up, the present invention can effectively prevent the moisture from entering the stator and the circuit board by the configuration of the protection cover and the seal ring, thereby simplifying the assembling process and reducing the production cost and manufacturing time.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A fan comprising:
a frame having a base disposed in the frame;
a circuit board;
a stator disposed on the base and electrically connected to the circuit board;
a rotor disposed in the frame and coupled to the stator; and
a protection cover assembled with the base, wherein the circuit board is located in a closed space defined by the protection cover and the base.

2. The fan according to claim 1, wherein the protection cover has an annular wall protruded and facing the circuit board.

3. The fan according to claim 2, further comprising a seal ring disposed around the annular wall of the protection cover.

4. The fan according to claim 3, wherein the base comprises a bottom part, a bushing extending from the center of the bottom part, and an extension part extending from the outer periphery of the bottom part, wherein the outer periphery of the protection cover touches against the extension part of the base to form the closed space, and the seal ring is disposed between the extension part and the annular wall of the protection cover for sealing the closed space.

5. The fan according to claim 4, wherein at least two wires are connected to the circuit board, and an outlet is disposed at the base for enabling the wires to pass therethrough to be connected to an external system.

6. The fan according to claim 5, wherein the outlet is sealed by a moisture-proof gel or a rubber.

7. The fan according to claim 4, wherein there is a predetermined distance set between the bottom part and an air outlet of the fan, the extension part protrudes out and extends from the outer periphery of the bottom part toward the air outlet of the fan, wherein the outer periphery of the protection cover touches against the inner surface of the extension part of the base so as to form the closed space.

8. The fan according to claim 7, wherein the bottom part of the base has a plurality of holes for enabling the stator to be electrically connected to the circuit board.

9. The fan according to claim 8, wherein the stator comprises a plurality of pins or wires passing through the holes for electrically connecting the stator to the circuit board.

10. The fan according to claim 9, wherein the bottom part of the base has a first pin accommodating structure protruded from the periphery of each of the holes.

11. The fan according to claim 10, wherein the hole located in the first pin accommodating structure has an outwardly expanded diameter.

12. The fan according to claim 10, wherein the hole located in the first pin accommodating structure is filled with a moisture-proof gel.

13. The fan according to claim 10, wherein the bottom part of the base has a second pin accommodating structure on the periphery of each of the holes, and the inner surface of the second pin accommodating structure closely contacts the outer surface of the pin.

14. The fan according to claim 4, wherein the protection cover has a plurality of holes enabling the stator to be electrically connected to the circuit board.

15. The fan according to claim 14, wherein the stator comprises a plurality of pins or wires passing through the holes of the protection cover for electrically connecting the stator to the circuit board.

16. The fan according to claim 15, wherein the protection cover has a first pin accommodating structure protruded from the periphery of each of the holes.

17. The fan according to claim 16, wherein the hole located in the first pin accommodating structure has an outwardly expanded diameter.

18. The fan according to claim 16, wherein the hole located in the first pin accommodating structure is filled with a moisture-proof gel.

19. The fan according to claim 16, wherein the protection cover has a second pin accommodating structure on the periphery of each of the holes, and the inner surface of the second pin accommodating structure closely contacts the outer surface of the pin.
